(19) United States
(12) Patent Application Publication
(10) Pub. No.: US 2025/0209646 A1
(43) Pub. Date: Jun. 26, 2025

(54) INDUSTRIAL SYSTEM CONTROL DEVICE, INDUSTRIAL SYSTEM, AND IMAGE ACQUISITION METHOD

(71) Applicant: FANUC CORPORATION, Yamanashi (JP)

(72) Inventor: Kazutaka IMANISHI, Yamanashi (JP)

(73) Assignee: FANUC CORPORATION, Yamanashi (JP)

(21) Appl. No.: 18/844,005

(22) PCT Filed: May 10, 2022
(86) PCT No.: PCT/JP2022/019862

§ 371 Date: Sep. 4, 2024

(51) Int. Cl. G06T 7/38

(52) U.S. Cl. CPC G06T 7/38; G06T 2207/10016; G06T 2207/10024; G06T 2207/20041; G06T 2207/20212

(57) ABSTRACT

One aspect of the present disclosure is an industrial system control device that controls: an imaging device that has an imaging element that generates captured images by capturing video of an object of which an image is formed at an imaging surface; and at least one industrial machine that has a plurality of drive axes that produce relative movement between the imaging device and the object. The industrial system control device comprises an imaging count determination unit that determines an imaging count for the imaging device, an imaging instruction unit that instructs the imaging device to perform imaging, a displacement amount determination unit that determines necessary displacement amounts for the image formation position of the object at the imaging surface, a drive amount calculation unit that calculates drive amounts for the drive axes to displace the image formation position of the object exactly the displacement amounts, a drive instruction unit that instructs the drive axes to perform drive of exactly the drive amounts, an operation adjustment unit that, before and after the drive instruction unit performs drive instruction, repeatedly makes the imaging instruction unit perform imaging instruction until the imaging count is reached, and an image synthesis unit that synthesizes a plurality of captured images captured by the imaging device to produce a single synthesized image.

### TECHNICAL FIELD

The present invention relates to an industrial system control device, an industrial system, and an image acquisition method.

### BACKGROUND ART

For example, in an industrial system including an industrial machine such as a machine tool for machining workpieces, an image of an object such as a workpiece may be captured by an imaging device, and various determinations may be made based on the image. To make a highly accurate determination, it may be desirable to obtain an image with a high resolution (number of pixels). In general, the resolution of an image depends on an imaging element, and an imaging device capable of capturing an image with a high resolution is expensive.

In a general imaging device, an imaging element is used to detect the intensity of one of RGB (three primary colors of light), for each pixel, and the intensities of the remaining two colors of light are interpolated based on the detection results of surrounding pixels. By performing such interpolation, a false color in which the color of the pixel is different from the actual color may occur, and accurate color information may not be obtained.

As a method of obtaining an image with accurate color information and high resolution, there has been proposed a technique of obtaining a high-quality image by combining a plurality of images captured by moving an imaging element by half the pixel pitch and a plurality of images captured by moving the imaging element by the pixel pitch, for example (for example, see Patent Document 1).

### CITATION LIST

### Patent Document

Patent Document 1: Japanese Unexamined Patent Application, Publication No. 2017-11329

### DISCLOSURE OF THE INVENTION

### Problems to be Solved by the Invention

An imaging device that combines high-quality images by moving an imaging element is also relatively expensive. Therefore, a technique for acquiring a high-quality image at relatively low cost in an industrial system is desired. Means for Solving the Problems

An industrial system control device according to one aspect of the present disclosure controls an imaging device including an imaging element for capturing an image of an object formed on an imaging surface to generate a captured image, and one or more industrial machines each including a plurality of drive axes for causing relative movement between the object and the imaging device. The industrial system control device includes an imaging number determination unit configured to determine a number of images to be captured by the imaging device; an imaging instruction unit configured to instruct the imaging device to capture an image; a displacement amount determination unit configured to determine a necessary displacement amount of an image forming position of the object on the imaging surface; a drive amount calculation unit configured to calculate a drive amount of each of the drive axes that displace the image forming position of the object by the displacement amount; a drive instruction unit configured to instruct each of the drive axes to drive by the drive amount; an operation adjustment unit configured to repeatedly cause the imaging instruction unit to execute an imaging instruction, with a drive instruction by the drive instruction unit inserted between repeated steps of causing the imaging instruction unit to execute the imaging instruction, until the number of images to be captured is reached; and an image composition unit configured to combine a plurality of images captured by the imaging device to generate one composite image.

### EFFECTS OF THE INVENTION

According to the present disclosure, it is possible to acquire a high-quality image at relatively low cost in an industrial system.

### BRIEF DESCRIPTION OF THE DRAWINGS

FIG. 1 is a schematic diagram showing the configuration of an industrial system according to a first embodiment of the present disclosure;

FIG. 2 is a flowchart showing a procedure of an embodiment of an image acquisition method in the industrial system of FIG. 1;

FIG. 3 is a schematic diagram showing the configuration of an industrial system according to a second embodiment of the present disclosure; and

FIG. 4 is a flowchart showing a procedure of an embodiment of an image acquisition method in the industrial system of FIG. 3.

### PREFERRED MODE FOR CARRYING OUT THE INVENTION

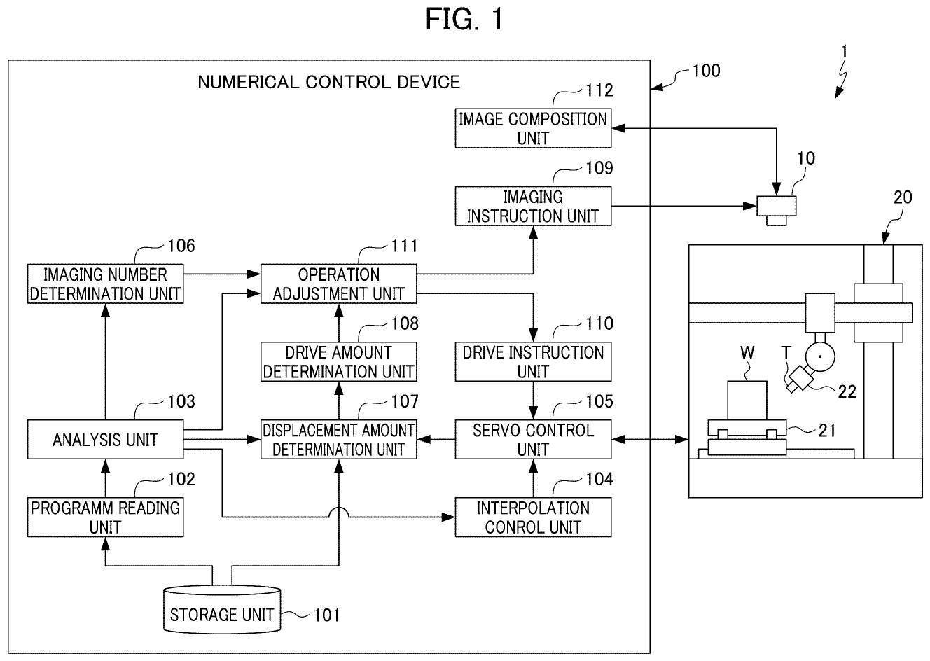

Hereinafter, embodiments of the present disclosure will be described with reference to the drawings. FIG. 1 is a schematic diagram showing the configuration of an industrial system 1 according to a first embodiment of the present disclosure.

The industrial system 1 includes an imaging device 10 that images an object W to generate a captured image, a machine tool 20 that movably holds the object W, and a numerical control device 100 that controls the imaging device 10 and the machine tool 20. The machine tool 20 is a type of industrial machine and can cause relative movement between the object W and the imaging device 10. A numerical control device 100 is itself an embodiment of an industrial system control device according to the present disclosure. The numerical control device 100 is also a device that automatically performs an embodiment of an image acquisition method according to the present disclosure in the industrial system 1.

The imaging device 10 is a digital camera including an imaging element that captures an image of an object formed on an imaging surface to generate a captured image, an optical system that forms an image of light from the object on the imaging element, and an electronic circuit that outputs an image signal generated by the imaging element as data of the captured image. In the present embodiment, the imaging device 10 can be fixed at a position where it can image a main part of the machine tool 20, that is, the object W placed on the machine tool 20, for example, above the machine tool 20.

In the present embodiment, the machine tool 20 includes a table 21 that holds the object W in a positionable manner, and a machining head 22 that machines the object W with a rotating tool T. The machine tool 20 of the present embodiment includes a plurality of drive axes that position the table 21 and thus the object W in at least the horizontal direction, a plurality of drive axes that position the rotating tool T, and a spindle that drives the rotating tool T.

The numerical control device 100 controls the machine tool 20 in accordance with a machining program. The numerical control device 100 includes a memory, a processor, an input/output interface, etc., and can be realized by one or more computer devices that execute appropriate control programs.

The numerical control device 100 includes a storage unit 101, a program reading unit 102, an analysis unit 103, an interpolation control unit 104, a servo control unit 105, an imaging number determination unit 106, a displacement amount determination unit 107, a drive amount calculation unit 108, an imaging instruction unit 109, a drive instruction unit 110, an operation adjustment unit 111, and an image composition unit 112. The components are ones that fall under categorized functions of the numerical control device 100, and do not need to be clearly distinguishable in terms of physical configuration or program configuration.

The storage unit 101 stores a machining program for specifying an operation of the machine tool 20 for machining the object W, specifications (pixel arrangement information, focal length, etc.) of the imaging device 10, the axis configuration of the machine tool 20, etc. The machining program can be written as a well-known numerical control program so as to specify a route along which the rotating tool T should be moved with respect to the object W, and a plurality of command points each indicating the coordinates through which the rotating tool T should pass.

The program reading unit 102 reads the machining program from the storage unit 101, and inputs the machining program to the analysis unit 103 in a processable form, for example, in units of blocks.

The analysis unit 103 analyzes the input machining program and calculates the position or speed of the drive axis that realizes the position or speed required for each of the table 21 holding the object W and the machining head 22.

The interpolation control unit 104 calculates the position or speed of each drive axis between command points written in the machining program.

The servo control unit 105 adjusts the electric power supplied to the servomotor of each drive axis so that the position or speed of each drive axis matches the position or speed calculated by the interpolation control unit 104.

The imaging number determination unit 106 determines the number of images to be captured required to acquire an image of the object W having the image quality required by the machining program. The number of images to be captured is preferably determined from integer multiples of 4 in accordance with the pixel arrangement information of the imaging device 10, and is typically 4 or 16. The number of images to be captured is the number of captured images required to perform well-known image composition for high image quality, and may be a fixed number in advance, or may be a preset number corresponding to a mode selected by a machining program or a user input. That is, the imaging number determination unit 106 can be configured to acquire a preset number of images to be captured.

The displacement amount determination unit 107 determines the displacement amount of the image forming position of the object W on the imaging surface required between the captured images used for image composition based on information such as the pixel arrangement of the imaging element. The displacement amount can be determined in accordance with the number of images to be captured determined by the imaging number determination unit 106 in accordance with the selected mode or the like. Specifically, it is preferable that the displacement amount for obtaining an image with improved resolution is a distance of 0.5 pixels in the imaging element, and the displacement amount for obtaining an image without false color is a distance of 1.0 pixels in the imaging element, that is, 0.5 times (half pixel pitch) or 1.0 times the pixel pitch of the imaging element, or an integer multiple thereof. Therefore, the displacement amount determination unit 107 may be configured to acquire a preset displacement amount.

The drive amount calculation unit 108 calculates the drive amount of the drive axis of the machine tool 20 that moves the object W in a plane perpendicular to the optical axis of the imaging device 10 so as to displace the image forming position of the object W by the displacement amount determined by the displacement amount determination unit 107. In a case where the coordinate system of the imaging device 10 (the imaging surface direction and the optical axis direction) and the coordinate system of the machine tool 20 do not coincide with each other, it is preferable that the drive amount calculation unit 108 converts the displacement amount in the coordinate system of the imaging device 10 into the displacement amount in the coordinate system of the machine tool 20 by coordinate transformation, calculates the movement amount of the object W corresponding to the displacement amount, and calculates the drive amount of each drive axis based on the movement amount. The drive amount necessary for moving the image forming position of the object W by the displacement amount, that is, the actual relative movement amount of the object W with respect to the imaging device 10 increases as the distance between the object W and the imaging device 10 increases even when the displacement amount is constant. Therefore, the drive amount calculation unit 108 is preferably configured to calculate the drive amount in consideration of the distance between the object W and the imaging device 10 calculated from the axis configuration and the position of each drive axis of the machine tool 20. Even when the distance between the object W and the imaging device 10 is the same, the displacement amount changes according to the optical system information at the in-focus position of the imaging device 10 relative to the object W. Specifically, the displacement amount is inversely proportional to the focal length and the imaging magnification of the optical system. Therefore, it is preferable to calculate the drive amount according to the focal length and the imaging magnification of the optical system, and the like. Further, even when the displacement amount is the same, since the drive amount may change depending on the positions and orientations of the object W and the imaging device 10, that is, the current position of each drive axis, the drive amount calculation unit 108 may be configured to calculate the drive amount in consideration of these. When the imaging device 10 is fixed, the position of the optical system in the imaging device does not change, and the axis configuration of the machine tool 20 can move the object only in the direction perpendicular to the optical axis, the drive amount corresponding to the displacement amount one-to-one may be set in advance.

The imaging instruction unit 109 instructs the imaging device 10 to capture an image. That is, the imaging instruction unit 109 outputs a command signal instructing imaging.

The drive instruction unit 110 inputs a command signal to the servo control unit 105 to drive the drive axis by the drive amount calculated by the drive amount calculation unit 108.

The operation adjustment unit 111 adjusts output timings of signals of the imaging instruction unit 109 and the drive instruction unit 110. Specifically, the operation adjustment unit 111 repeatedly causes the imaging instruction unit 109 to execute the imaging instruction, with the drive instruction by the drive instruction unit 110 inserted between repeated steps of causing the imaging instruction unit 109 to execute the imaging instruction, until the number of images to be captured is reached. That is, the operation adjustment unit 111 controls the imaging instruction unit 109 and the drive instruction unit 110 to repeatedly perform imaging with the imaging device 10 and move the machine tool 20 to displace the image forming position of the object W by the displacement amount.

The image composition unit 112 acquires the captured images of the number of images to be captured from the imaging device 10 and combines the captured images of the number of images to be captured to generate one composite image in which the color information of each pixel is accurate, the resolution is high (the number of recorded pixels is large), or the color information is accurate and the resolution is high. The combination of the number of images to be captured and the displacement amount and the composition of images are well known techniques, and thus detailed descriptions thereof will be omitted.

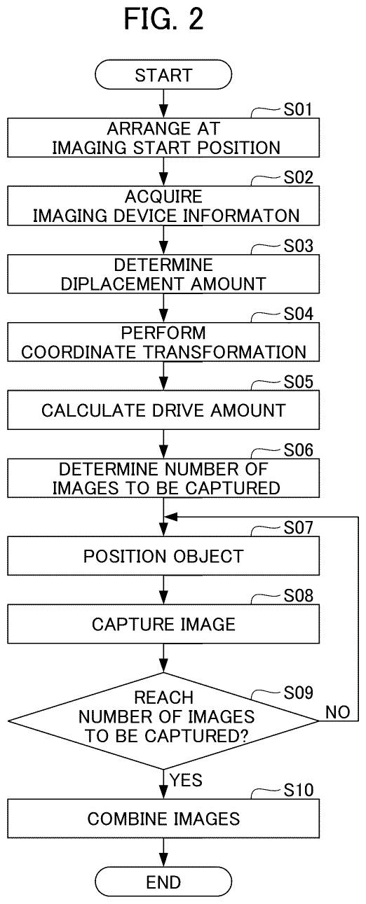

As shown in FIG. 2, an embodiment of an image acquisition method according to the present disclosure performed by the numerical control device 100 in the industrial system 1 includes a step of arranging the object W by the machine tool 20 at an imaging start position (Step S01), a step of acquiring imaging device information (Step S02), a step of determining a displacement amount in the coordinate system of the imaging device 10 (Step S03), a step of performing coordinate transformation of the displacement amount in the coordinate system of the imaging device 10 to the displacement amount in the coordinate system of the machine tool 20 (Step S04), a step of calculating the drive amount of the drive axis that displaces the image forming position of the object W by the displacement amount (Step S05), a step of determining the number of images to be captured (Step S06), a step of positioning the object W at an imaging position by the machine tool 20 (Step S07), a step of causing the imaging device 10 to capture an image (Step S08), a step of checking whether the number of images to be captured has been reached (Step S09), and a step of combining a plurality of captured images (Step S10).

In the image acquisition method according to the present embodiment, when the number of times of imaging has reached the number of images to be captured in Step S09, the process advances to Step S10, but when it has not reached the number of images to be captured, the process returns to Step S07. That is, in the image acquisition method of the present embodiment, the step of causing the imaging device 10 to capture an image (Step S08) is repeated, with the step of driving the drive axis so as to move the image forming position of the object W on the imaging surface (Step S07) inserted between repeated steps of causing the imaging device 10 to capture an image, until the number of images to be captured is reached. The drive amount of the drive axis of the machine tool 20 in the step of driving the drive axis in Step S07 is determined by a method including the step of determining a necessary displacement amount of the image forming position of the object W on the imaging surface (Step S03) and the step of calculating the drive amount of the drive axis that displaces the image forming position of the object W by the displacement amount (Step S05).

In the industrial system 1, the numerical control device 100 causes the machine tool 20 to move the object W, so that a plurality of captured images displaced by a certain displacement amount can be acquired using the imaging device 10 that does not have a function of moving the imaging element. By combining the plurality of captured images, the industrial system 1 can acquire a high-quality composite image with high color accuracy while having a relatively inexpensive configuration.

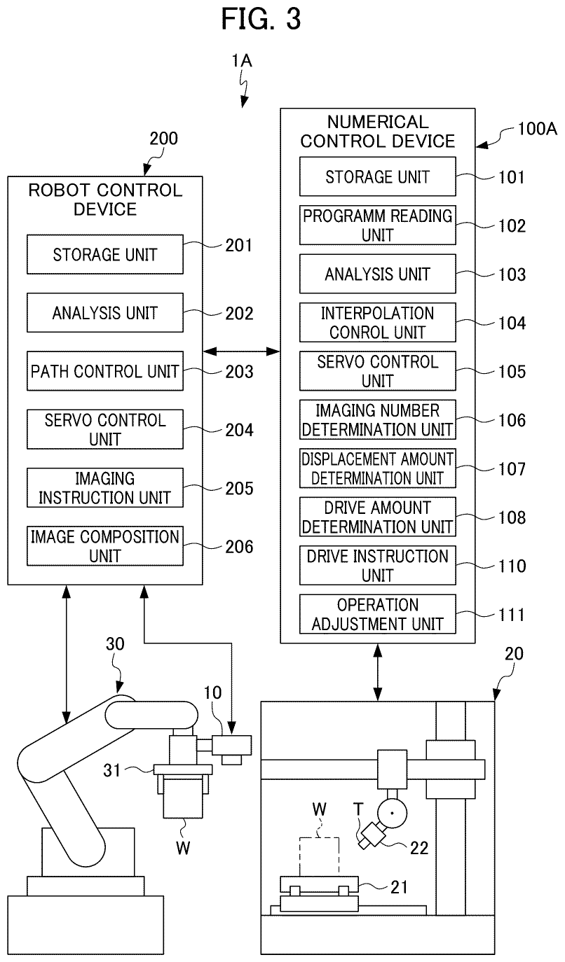

Next, a second embodiment of the present disclosure will be described. FIG. 3 is a schematic diagram showing the configuration of an industrial system 1A according to a third embodiment of the present disclosure. In the description of the present embodiment, the same components as those of the first embodiment are denoted by the same reference numerals, and redundant descriptions thereof may be omitted.

The industrial system 1A includes an imaging device 10 that images an object W to generate a captured image, a machine tool 20 that is a first industrial machine capable of causing relative movement between the object W and the imaging device 10, a robot 30 that is a second industrial machine that replaces the object W and holds the imaging device 10 in a positionable manner, a numerical control device 100A that controls the imaging device 10 and the machine tool 20, and a robot control device 200 that controls the imaging device 10 and the robot 30. The numerical control device 100A and the robot control device 200 are another embodiment of the industrial system control device according to the present disclosure. The numerical control device 100A and the robot control device 200 are also devices that automatically execute another embodiment of the image acquisition method according to the present disclosure in the industrial system 1A.

As shown in FIG. 3, the robot 30 can be a vertical articulated robot, but is not limited thereto, and may be, for example, an orthogonal coordinate robot, a scalar robot, a parallel link robot, or the like. In the robot 30, a hand 31 for gripping the object W, and the imaging device 10 are attached to its distal end. That is, the robot 30 can cause relative movement between the object W and the imaging device 10 by positioning the imaging device 10.

The numerical control device 100A can be realized by a computer device similar to the numerical control device 100 of the first embodiment. The numerical control device 100A includes the storage unit 101, the program reading unit 102, the analysis unit 103, the interpolation control unit 104, the servo control unit 105, the drive instruction unit 110, and the operation adjustment unit 111. That is, the numerical control device 100A does not include some of the functions of the numerical control device 100 of the first embodiment.

The robot control device 200 includes a memory, a processor, an input/output interface, etc., and can be realized by one or more computer devices that execute appropriate control programs. The robot control device 200 includes a storage unit 201, an analysis unit 202, a path control unit 203, a servo control unit 204, an imaging instruction unit 205, and an image composition unit 206. The components of the robot control device 200 are also ones that fall under categorized functions, and do not need to be clearly distinguishable.

The storage unit 201 of the robot control device 200 stores a work program for operating the robot 30 that replaces the object W, axis configuration information of the robot 30, and the like. The analysis unit 202 analyzes the work program and specifies the operation of the robot 30. The path control unit 203 complements the operation written in the work program as necessary, and calculates the positions or speeds of the respective drive axes of the robot 30 for each time. The servo control unit 204 controls the servo motors of the respective drive axes of the robot 30 so as to realize the positions or the speeds calculated by the path control unit 203.

The imaging instruction unit 205 and the image composition unit 206 of the robot control device 200 are functionally similar to the imaging instruction unit 109 and the image composition unit 112 of the numerical control device 100 of the first embodiment. These components exchange various data with the drive instruction unit 110 and the operation adjustment unit 111 of the numerical control device 100A to implement an image acquisition method capable of acquiring a high-quality image similar to that of the numerical control device 100 of the first embodiment.

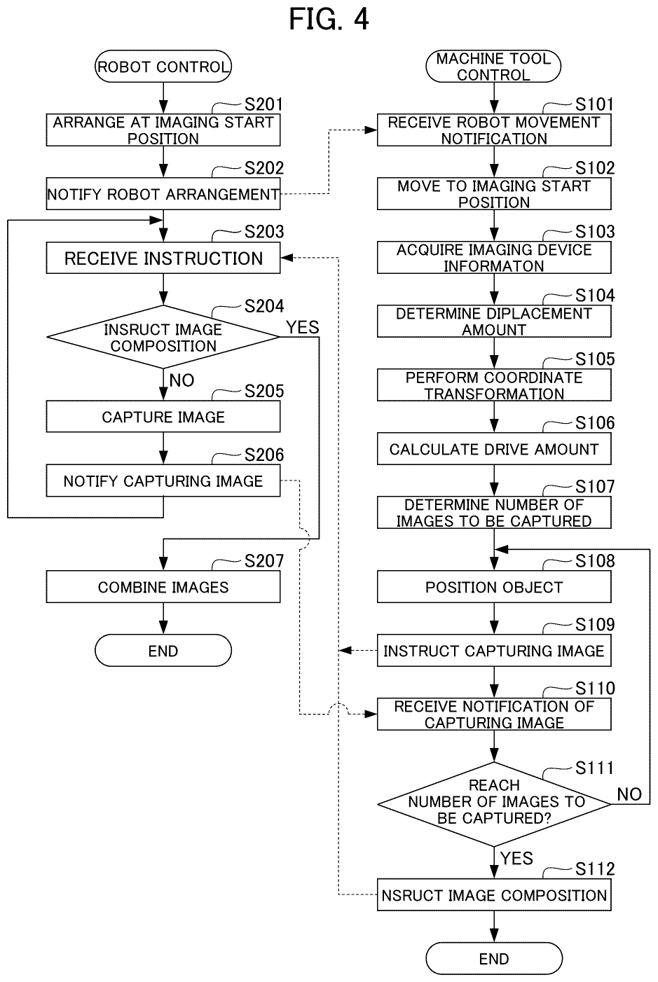

As shown in FIG. 4, the image acquisition method performed by the numerical control device 100A and the robot control device 200 in cooperation with each other in the industrial system 1A includes a machine tool control procedure in which the numerical control device 100A controls the machine tool 20, and a robot control procedure in which the robot control device 200 controls the robot 30 and the imaging device 10.

The machine tool control procedure includes a step of receiving a notification of arrangement of the imaging device 10 at an imaging start position from the robot control device 200 (Step S101), a step of arranging the object W at a predetermined imaging start position (Step S102), a step of acquiring imaging device information (Step S103), a step of determining the displacement amount of the image forming position (Step S104), a step of perform coordinate transformation of the displacement amount (Step S105), a step of calculating the drive amount of the drive axis (Step S106), a step of determining the number of images to be captured (Step S107), a step of positioning the object W at an imaging position (Step S108), a step of instructing the robot control device 200 to capture an image (Step S109), a step of receiving a notification of completion of imaging from the robot control device 200 (Step S110), a step of checking whether the number of images to be captured has been reached (Step S111), and a step of instructing the robot control device 200 to composite images (Step S112). When the number of images to be captured has been reached in Step S111, the process returns to Step S108.

The robot control procedure includes a step of arranging the imaging device 10 at a predetermined imaging start position by the robot 30 (Step S201), a step of notifying the numerical control device 100A of the arrangement at the imaging start position by the robot 30 (Step S202), a step of receiving an instruction from the numerical control device 100A (Step S203), and a step of checking whether the instruction from the numerical control device 100A is an instruction for image composition (Step S204), a step of causing the imaging device 10 to capture an image when the instruction from the numerical control device 100A is not an instruction for image composition (Step S205), a step of notifying the numerical control device 100A of capturing the image (Step S206), and a step of combining a plurality of captured images when the instruction from the numerical control device 100A is an instruction for image composition (Step S206).

In the industrial system 1A, the imaging device 10 is positioned using the robot 30 that handles the object W, so that the object W can be imaged from any direction. Further, in the industrial system 1A, a plurality of captured images can be acquired while the machine tool 20 finely adjusts the relative position of the object W with respect to the imaging device 10, so that a high-quality image can be acquired.

Although the embodiments of the present disclosure have been described above, the present disclosure is not limited to the above-described embodiments. The effects described in the above-described embodiments are merely listed as advantageous effects generated from the present invention, and the effects of the present invention are not limited to those described in the above-described embodiments.

In the present invention, any industrial machine may be used to position the imaging device and the object. For example, the imaging device may be movably held by a machining head of a machine tool, or the object may be held by a robot. Further, in the present invention, the image forming position of the object may be displaced by the displacement amount by moving the imaging device. As an example, the industrial system according to the present invention may include the first industrial machine (for example, the machine tool) that holds the object in a positionable manner, and the second industrial machine (for example, the robot) that holds the imaging device in a positionable manner, and the drive amount calculation unit may be configured to drive one of the first industrial machine and the second industrial machine having a higher resolution of the drive axes with respect to the displacement amount.

### EXPLANATION OF REFERENCE NUMERALS

1, 1A industrial system
10 imaging device
20 machine tool
21 table
22 machining head
30 robot
31 hand
100, 100A numerical control device
101 storage unit
102 program reading unit
103 analysis unit
104 interpolation control unit
105 servo control unit
106 imaging number determination unit
107 displacement amount determination unit
108 drive amount calculation unit
109 imaging instruction unit
110 drive instruction unit
111 operation adjustment unit
112 image composition unit
201 storage unit
202 analysis unit
203 path control unit
204 servo control unit
205 imaging instruction unit
206 image composition unit
T rotating tool
W object

1. An industrial system control device for controlling: an imaging device including an imaging element for capturing an image of an object formed on an imaging surface to generate a captured image; and one or more industrial machines each including a plurality of drive axes for causing relative movement between the object and the imaging device, the industrial system control device comprising:
an imaging number determination unit configured to determine a number of images to be captured by the imaging device;
an imaging instruction unit configured to instruct the imaging device to capture an image;
a displacement amount determination unit configured to determine a necessary displacement amount of an image forming position of the object on the imaging surface;
a drive amount calculation unit configured to calculate a drive amount of each of the drive axes that displace the image forming position of the object by the displacement amount;
a drive instruction unit configured to instruct each of the drive axes to drive by the drive amount;
an operation adjustment unit configured to repeatedly cause the imaging instruction unit to execute an imaging instruction, with a drive instruction by the drive instruction unit inserted between repeated steps of causing the imaging instruction unit to execute the imaging instruction, until the number of images to be captured is reached; and
an image composition unit configured to combine a plurality of images captured by the imaging device to generate one composite image.

2. The industrial system control device according to claim 1, wherein the drive amount calculation unit calculates the drive amount in consideration of a distance between the object and the imaging device, the distance being calculated from positions of the plurality of drive axes of each of the one or more industrial machines.

3. The industrial system control device according to claim 1, wherein the displacement amount is an integer multiple of a half pixel pitch or an integer multiple of a pixel pitch of the imaging element.

4. The industrial system control device according to claim 1, wherein the imaging number determination unit determines the number of images to be captured from among integer multiples of four in accordance with pixel arrangement information of the imaging device.

5. An industrial system comprising: an imaging device configured to image an object; one or more industrial machines configured to cause relative movement between the object and the imaging device; and the industrial system control device according to claim 1.

6. The industrial system according to claim 5, wherein the one or more industrial machines include a machine tool that holds the object in a positionable manner and machines the object.

7. The industrial system according to claim 5, wherein the one or more industrial machines include a robot that holds the imaging device in a positionable manner.

8. An industrial system according to claim 5, wherein
the one or more industrial machines include a first industrial machine that holds the object in a positionable manner, and a second industrial machine that holds the imaging device in a positionable manner, and
the drive amount calculation unit calculates the drive amount so as to drive one of the first industrial machine and the second industrial machine having a higher resolution of the drive axes with respect to the displacement amount.

9. A method for acquiring an image of an object in an industrial system comprising: an imaging device including an imaging element for capturing an image of an object formed on an imaging surface to generate a captured image; and one or more industrial machines each including a plurality of drive axes for causing relative movement between the object and the imaging device, the method comprising:
determining a number of images to be captured by the imaging device;
determining a necessary displacement amount of an image forming position of the object on the imaging surface;
calculating a drive amount of each of the drive axes that displace the object by the displacement amount;
repeatedly causing the imaging device to capture an image, with driving the drive axes so as to move the image forming position of the object on the imaging surface inserted between repeated steps of causing the imaging device to capture the image, until the number of images to be captured is reached; and
combining a plurality of images captured by the imaging device to generate one composite image.
